(19) United States
(12) Patent Application Publication
(10) Pub. No.: US 2010/0283578 A1
(43) Pub. Date: Nov. 11, 2010

(54) Transponder Bolt Seal and a Housing for a Transponder

(76) Inventor: Matthew Henderson, New South Wales (AU)

Correspondence Address: KING & SPALDING, 1180 PEACHTREE STREET , NE, ATLANTA, GA, 30309-3521, US

(21) Appl. No.: 12/664,275

(22) PCT Filed: Jun. 16, 2008
(86) PCT No.: PCT/AU2008/000869

§ 371 Date: Jul. 13, 2010

(30) Foreign Application Priority Data
Jun. 15, 2007 (AU) 2007903240

(51) Int. Cl. G05B 19/00

(52) U.S. Cl. 340/5.6

(57) ABSTRACT

An electronic seal (300) is described. The seal includes a sealing mechanism (301, 302) for sealing a value item and a cover (304), which inhibits access to the sealing mechanism (301, 302). A trigger (303) is held in a substantially fixed relationship relative to the sealing mechanism (301, 302) when the cover (304) is moved away from the sealing mechanism (301, 302). The trigger (303) holds in position a tensioned spring (305), which is released when the cover (304) is moved away from the sealing mechanism (301, 302). The released spring (107) then impacts part of a transponder (201) in the electronic seal (300).

### FIELD OF THE INVENTION

This invention relates to electronic security seals. It also relates to housings for transponders. In particular, but not exclusively, certain embodiments of the present invention relate to electronic security seals for use on shipping containers.

### BACKGROUND OF THE INVENTION

The security of containers has become an important issue in today's security-conscious environment. This is particularly apparent in the shipping of containers across borders. The locking of loaded containers to prevent unauthorised access after the containers have been loaded and before the containers reach their destination is now seen as an important, if not mandatory security precaution.

Of course, a lock on a container may be removed and then replaced. Therefore, it is important that tampering with a lock is able to be detected. To assist with the identification of tampering with locks, electronic seals have been utilised.

One form of electronic seal that has been used in the past is an electronic tagging device that wirelessly transmits information to an interrogator. This information identifies whether the lock has been tampered with.

U.S. Pat. No. 6,265,973 (Brammall et al.) describes an electronic security seal. A conductor along the bolt shank is connected to a circuit and provides a tamper evident signal to the circuit when the bolt is severed. The circuit senses removal of the bolt or severed bolt condition and generates a “tamper” signal, which is transmitted to a local receiver/reader.

U.S. Pat. No. 6,747,558 (Thorne et al.) describes a method and apparatus for providing container security with a tag. A device includes a bolt, which extends through openings in a latch mechanism on the container. The bolt also passes through spaced coils of the seal device. The sealed device uses one coil to generate a magnetic field, while monitoring the corresponding magnetic field induced in the other coil. Tampering with the bolt affects the magnetic field, which in turn permits the seal device to detect the tampering. The seal device periodically transmits wireless signals, which can be remotely received for the purpose of tracking the container and monitoring the integrity of the seal.

A major disadvantage of providing sophisticated electronic security seals is the increased cost involved in shipping containers. Even if the devices are made to be reusable, there is the associated cost, inconvenience and possible additional security issues related to the reuse of electronic seals. In addition, electronic seals that actively transmit signals may be subject to stringent regulations regarding the maximum power of transmission and the frequency bands in which transmissions may be made. These regulations may change from jurisdiction to jurisdiction and over time. There is also the problem of passive transponders interfering with the signals from other passive transponders when interrogated. This problem remains even in applications where evidence of tampering with a lock is not required.

Apart from the sealing function of electronic seals, there are many other applications where removal or tampering with a value item needs to be detected.

It is therefore an object of the present invention to overcome or ameliorate problems with electronic seals and/or transponder devices at present, or at least to provide the public with a useful alternative.

Any reference in this specification to the prior art does not constitute, nor should it be considered, an admission that such prior art was widely known or forms part of the common general knowledge in Australia, or in any other jurisdiction, before the priority date of any of the appended claims.

### SUMMARY OF THE INVENTION

According to one aspect of the invention, there is provided an electronic seal comprising a sealing mechanism for sealing a value item, a transponder receptacle, and a cover engaged with the sealing mechanism and which inhibits access to the sealing mechanism, wherein the sealing mechanism comprises or connects to a trigger, which is held in a substantially fixed relationship relative to the sealing mechanism when the cover is moved away from the sealing mechanism, the cover holds therein a spring, which is held in a tensioned position by the trigger, and wherein the trigger and spring are located so that when the cover is moved away from the sealing mechanism, the trigger releases the spring, which moves and impacts the transponder, rendering the transponder inoperable.

In one embodiment, the transponder comprises a chip and antenna structure held in the transponder receptacle, which forms a part of the cover. In this embodiment, the cover may include a rear housing component positioned towards the sealing mechanism, and a front housing component, and the chip and antenna structure may be clamped between the rear housing component and front housing component. Also, the antenna structure may be flexible and the cover may have a curved profile so as to maintain the antenna structure in a curved shape. The chip may instead be mounted on a printed circuit board. The antenna structure may also be mounted on this printed circuit board.

In one embodiment, the cover includes an aperture with an internal opening that opens to the transponder receptacle and an external opening that receives therein the trigger. In this embodiment, the spring may be a resilient elongate member tensioned in a bent configuration and the cover may include an internal spring guide about the internal opening. At least a portion of the transponder then extends into and is held in the area occupied by the spring guide. In operation the spring is released by the trigger and cover moving relative to each other so as to withdraw the trigger into the internal opening, and the resulting movement of the spring is guided and constrained by the spring guide so as to impact and damage the portion of the transponder that extends into the spring guide. In this embodiment, the spring guide may be a fan-shaped guide and the cover may include a spring holder at the base of the fan in which the spring is located and held.

In one embodiment, the trigger is movable relative to the sealing mechanism and moves from a first position to a second position when the sealing mechanism is moved from an unlocked into a locked position. In this embodiment, the trigger, when in the first position, may render the transponder inoperative to transmit a signal. To affect this, the trigger may include a conductive end, which contacts the transponder when the trigger is in the first position to render the transponder inoperative to transmit a signal. The trigger may move away from the transponder when moving to the second position, allowing the transponder to transmit a signal. The trigger thereby acts as a switch with the conductive end allowing the activation and deactivation of the transponder. The trigger may be held in the second position when the sealing mechanism is in the locked position so as to prevent movement back to the first position while the sealing mechanism remains in the locked position.

In one embodiment, the trigger rotates about an axis when the sealing mechanism is moved from an unlocked into a locked position. In this embodiment, the trigger includes a holder for the spring, wherein when the sealing mechanism is in the locked position, the holder allows the trigger to release the spring when the cover is moved a certain distance away from the sealing mechanism. When the sealing mechanism is in the unlocked position, the guide prevents release of the spring when the housing is moved away from the sealing mechanism by said certain distance.

In one embodiment, the trigger includes a cavity in which a portion of the transponder is located at least when the sealing mechanism is in the locked position, wherein the spring damages said portion of the transponder when released. In this embodiment, the portion of the transponder located in the cavity is a chip of the transponder.

In one embodiment, the cover is releasable from the sealing mechanism. In this embodiment, the cover is released from the sealing mechanism by actuating an actuator. Actuation of the actuator to release the cover damages the transponder, rendering it inoperable. The cover may only be releasable from the sealing mechanism by either actuating the actuator or by forcibly removing the cover, for example by leveraging it away from the sealing mechanism using a lever like a crow bar.

According to another aspect of the invention, there is provided a cover for an electronic seal, the cover adapted to be able to be securely engaged with a sealing mechanism for sealing a value item, to thereby inhibit access to the sealing mechanism, wherein the cover includes therein a transponder, a spring, and a trigger that holds the spring in a tensioned configuration, wherein the trigger is arranged to remain substantially in position relative to the sealing mechanism when the cover is engaged with the sealing mechanism and is movable relative to the cover, the arrangement resulting in release of the spring when the cover is moved away from the sealing mechanism, and wherein the spring and transponder are located within the cover so that when the spring is released, it impacts the transponder, rendering the transponder inoperable.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1: shows a front elevation of an electronic seal in an unlocked position, according to one embodiment of the present invention.

FIG. 2: shows a cross section through line AA of FIG. 1.

FIG. 3: shows a cross section through line BB of FIG. 1.

FIG. 4: shows a front elevation of the electronic seal of FIG. 1 in a locked position.

FIG. 5: shows a cross section through line CC of FIG. 4.

FIG. 6: shows a cross section through line DD of FIG. 4.

FIG. 7: shows a front view of an RFID according to an aspect of the present invention. The RFID may be suitable for use with the electronic seal of FIG. 1.

FIG. 8: shows a front elevation of the seal of FIG. 1 during the removal of a cover from the seal.

FIG. 9: shows a cross section through line EE of FIG. 8.

FIG. 10: shows a cross section through line FF of FIG. 8.

FIG. 11: shows diagrammatically, an alternative biasing mechanism for an electronic seal of an embodiment of the present invention.

FIG. 12: shows diagrammatically an exploded view of components of another embodiment of an electronic seal.

FIG. 13: shows the components depicted in FIG. 12 when assembled.

FIG. 14: shows the electronic seal of FIG. 12, without the printed circuit board.

FIG. 15: shows the electronic seal of FIG. 12 with the spring released to remove a chip from the printed circuit board.

FIG. 16: shows an exploded view of components of an electronic seal according to the embodiment shown in FIG. 12.

FIG. 17: shows a cutaway view of the components of FIG. 16 when partially assembled.

FIG. 18: shows a cutaway view of the components of FIG. 16 when assembled.

### DETAILED DESCRIPTION OF THE EMBODIMENTS

The present invention relates to an electronic seal. The electronic seal may be used to seal a value item, which may be any item that requires sealing, regardless of its monetary value. By way of example only, the electronic seal may be used to seal containers, a door to a room or compartment, or a control panel or button. The shape of the electronic seal and the mechanism by which the value item is sealed will vary depending on the application.

The electronic seal may have particular application to the sealing of shipping containers and may provide advantages and functionally that make it particularly suited to this application. The following description is therefore provided with specific reference to an electronic seal for a shipping container. Variations and/or modifications to the electronic seal of the present invention to make the electronic seal suitable or more suited to other applications will be apparent to those skilled in the relevant arts, and such variations and/or modifications are intended to be within the scope of the present invention.

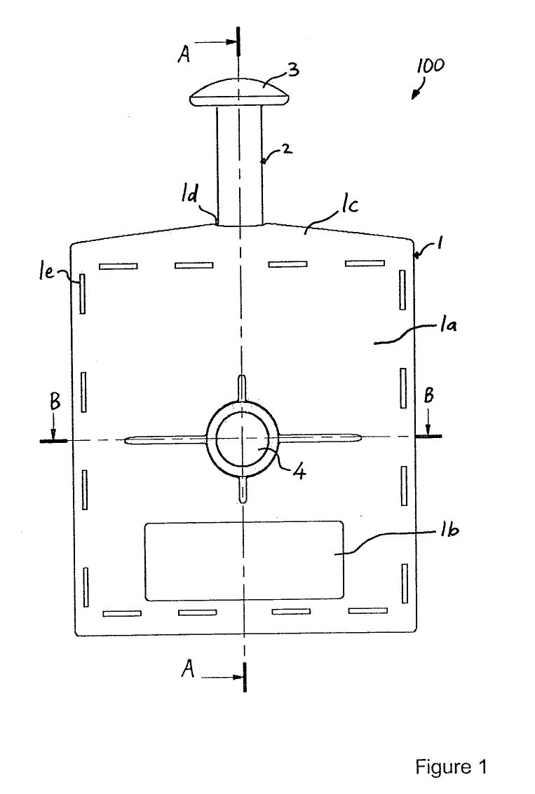

FIG. 1 of the accompanying drawings shows a front elevation of an electronic seal according to a first embodiment of the present invention, which is generally referenced by arrow 100. The seal 100 includes a cover 1, a bolt 2 having a head 3, and a button 4. The cover 1 has a curved front face 1a and may optionally include a planar section 1b, on which a barcode or other indicator may be placed. The cover 1 includes a shoulder 1c that extends to the bolt 2 when the bolt is in position to secure the cover 1 to a container, as will be described in more detail herein below. The shoulder 1c may terminate in a curved recess 1d complementary to the peripheral shape of the bolt 2.

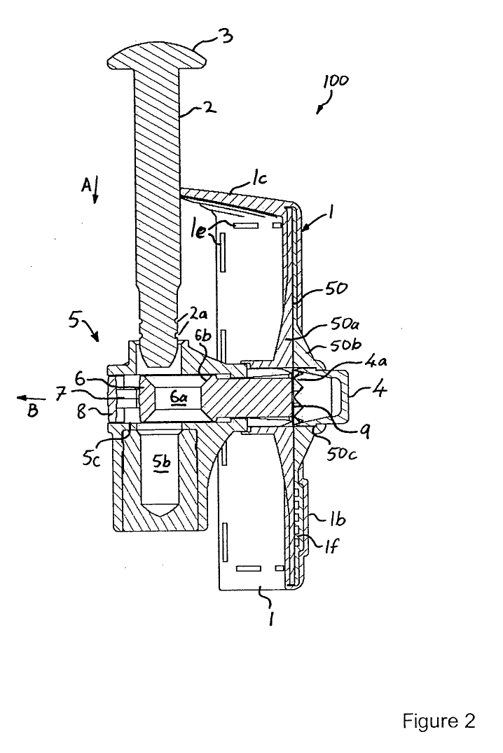

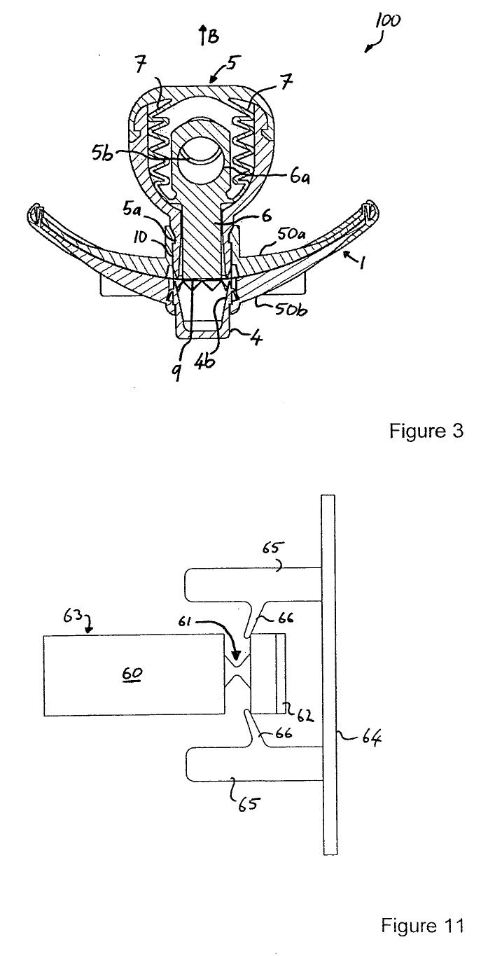

A cross-sectional view through the cover 1 and the bolt 2 through line AA of FIG. 1 is shown in FIG. 2 and in FIG. 3 a cross-sectional view through line BB of FIG. 1 is shown.

The cover 1 includes a receptacle for a transponder (not shown in FIGS. 2 and 3), which holds the transponder in place. In the preferred embodiment the transponder receptacle is in the form of a clamp 50 that holds a part of a transponder. The part of the transponder held by the clamp 50 may be one or more antennas. However, other forms of transponder receptacle may be used, or required, depending on the particular shape and configuration of the transponder that is used. The seal 100 may be particularly suited for use with passive transponders and this represents the most preferred embodiment of the invention, although the present invention may also have application to seals having an active transponder.

The clamp 50 includes two parts 50a and 50b, which are brought together to hold the transponder, which is suitably a radio frequency identification device (RFID), between them. Prior to locating a RFID in the clamp 50, a button 4 is inserted into a central aperture 50c of the clamp 50. The rest of the cover 1 is over-moulded about the clamp 50. During the over-moulding process, the clamp 50 may be held by mechanical supports in a known manner, the removal of these mechanical support creating apertures 1e in the cover 1. In order to maintain a uniform thickness of the clamp 50 in the region of the planar section 1b, the clamp 50 may have a comb shape 1f in this region.

The cover 1 is shaped so that once an RFID has been inserted in the clamp 50 and the rest of the cover 1 moulded about the clamp 50, the RFID can not be removed from the cover 1 without damaging the cover 1. This is one aspect of the seal 100 that contributes to its characteristic of being a tamper evident seal.

FIGS. 2 and 3 further show a cross-section through a sealing mechanism 5. The sealing mechanism 5 in this embodiment is adapted to receive the bolt 2. Accordingly, the seal 100 shown in the accompanying drawings has been adapted to seal a value item that can be locked by the bolt 2, for example by using the bolt 2 to lock the doors of a shipping container closed, in which case the bolt 2 may be inserted through two eyes of the shipping container's doors and then into the sealing mechanism 5. Mechanisms for engaging with and securely holding a bolt are well known and will therefore not be described herein. Variations and/or modifications to the sealing mechanism 5 may be required to seal other value items.

The sealing mechanism 5 is engaged with the clamp 50 of the cover 1 through an interlocking engagement mechanism 5a (see FIG. 3). In alternative embodiments where the cover 1 is shaped differently, the sealing mechanism 5 may engage with another part of the cover 1.

The sealing mechanism 5 includes a first shaft 5b and a second shaft 5c, which extend transverse to each other and intersect one another. The first shaft 5b is shaped, dimensioned and oriented to receive the bolt 2 and engage with circumferential rings 2a provided on the bolt 2 so as to prevent the bolt 2 from being removed from the shaft 5b after it has been inserted.

The second shaft 5c, which in the embodiment shown in the accompanying drawings is formed in one part by the clamp 50 and in another part by the sealing mechanism 5, contains a movable member 6, which includes an aperture 6a through it and which has a frusto-conical shaped opening 6b on the side of the aperture 6a that receives the bolt 2. In FIG. 2, a similar shaped opening to opening 6b is also provided on the opposite side of the aperture 6a, but this is not necessary. When the bolt 2 is moved downwards in the direction shown by arrow A, the bolt 2 contacts a side wall of the opening 6b and forces the movable member 6 to move in the direction indicated by arrow B. This movement is against the force of a biasing device, referred to herein as a spring 7, which extends between the movable member 6 and a cap 8 and which is fixedly engaged with the sealing mechanism 5. The spring 7 may be any suitable biasing device or material, including a coiled metal or plastic strip and a resilient soft material such as rubber. In addition, the spring 7 may be replaced or used in addition to another biasing device operable to pull the movable member 6 in the opposite direction to arrow B, such device possibly being an elastic material extending between the movable member 4 and the second shaft 5c.

A conductive ring 9 is located at the distal end of the movable member 6 from the cap 8. The conductive ring 9 is annular shaped and is dimensioned to extend around a chip on the RFID, thereby shorting out the chip and preventing the RFID from transmitting a signal in response to an interrogation signal. Any suitably shaped conductive body may be used instead of the conductive ring 9, provided that the conductive body effectively renders the RFID inoperable when it is in contact with the RFID.

Before the seal 100 is used to lock a container, the RFID is maintained in an inoperable state due to the conductive ring 9 being pressed against the RFID by the spring 7. The RFID is only transformed into an operable state after the bolt 2 has been inserted into the receptacle 5b through the aperture 6a of the movable member 6. As can be seen from FIG. 3, the conductive ring 9 is in the plane of the intersecting parts 50a, 50b of the clamp 50. The spring constant of the spring 7 should be selected to be sufficiently high to maintain the conductive ring 9 in contact with the necessary conductors on the RFID to render the RFID inoperative and sufficiently low so as to not cause damage to the RFID. To further assist in the prevention of damage, the movable member 6 may have an elastic portion along it, to absorb shock applied to the seal 100, for example during transit. This elastic portion may perform the dual function of providing a point of weakening in the movable member 6 as is explained in more detail herein below in relation to FIG. 11.

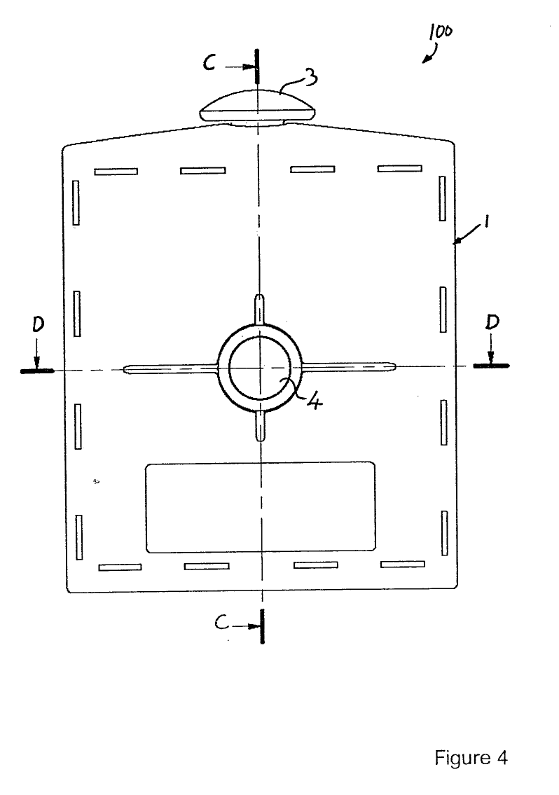

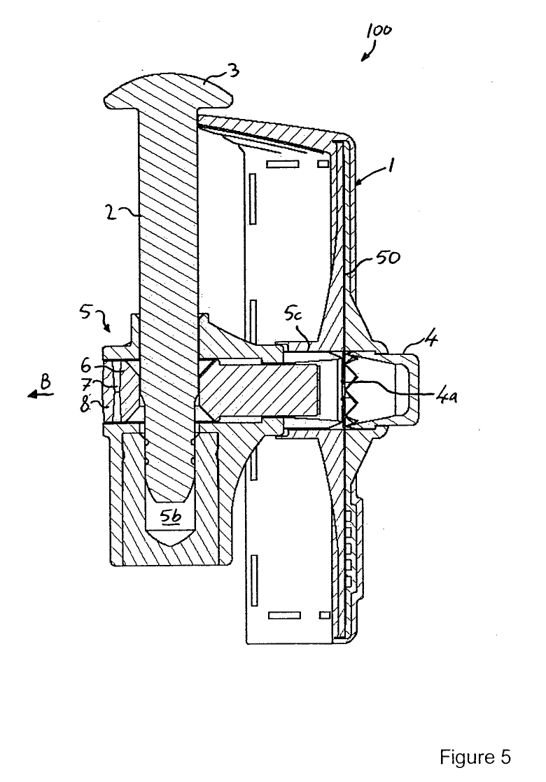

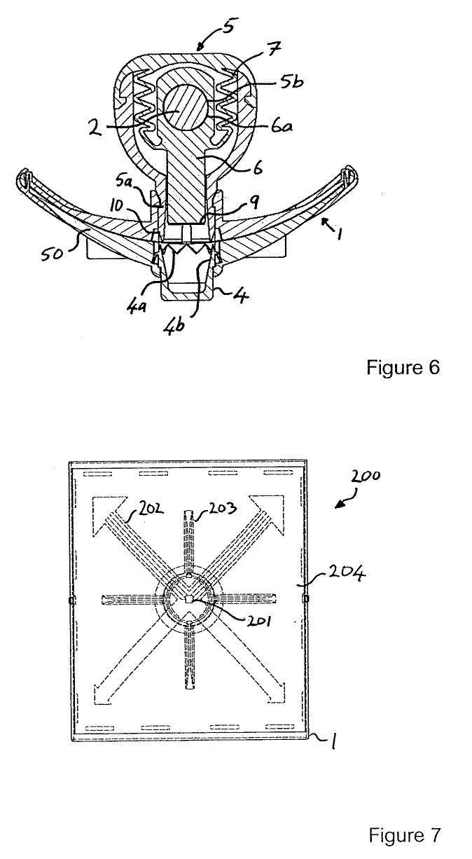

The seal 100 of the present invention therefore maintains an RFID in an inoperable state until the seal 100 has been applied to a container. This controls when the seal 100 can transmit a signal in response to an interrogation signal. FIG. 4 shows a front view of the seal 100 with the bolt 2 inserted into the receptacle 5b, FIG. 5 shows a cross-sectional view through line CC of FIG. 4 and FIG. 6 shows a cross-sectional view through line DD of FIG. 4. As can be seen particularly from FIG. 4, when the bolt 2 is inserted into the receptacle 5b, the cover 1 extends up to the head of the bolt 2. This prevents access to the bolt 2 to prevent cutting of the bolt without visibly damaging the cover 1. Even if the bolt was able to be cut immediately below the head 3 without damaging the cover, the shaft of the bolt 2 would still extend through the value item and removing the shaft would likely still necessitate damage to at least the shoulder 1c of the cover 1.

Inserting the bolt 2 into the receptacle 5b through the aperture 6a causes the aperture 6a to align with the receptacle 5b by moving in direction B, against the opposing force of the spring 7. This also moves the ring 9 in direction B, taking it out of the plane occupied by the intersecting parts 50a, 50b of the clamp 50 and allowing an RFID held by the clamp 50 to operate.

Those skilled in the relevant arts will appreciate that there are alternative methods of maintaining a transponder in an inoperable state and then changing the transponder to an operable state. The methods available for a seal of the present invention may be dictated by the particular transponder that is used. For example, different methods may be available for actuating active transponders between an operative and inoperative state than for passive transponders and transponders having different structures and functionality can be actuated between operable and inoperable states by different methods. The operation of the seal to change the state of the transponder may be mechanical in nature, for example by moving a conductive object, or electronic, for example by changing the state of a chip that implements a simple state machine. Whatever method of actuation is used, the seal of the present invention has the advantage of not having to be constantly in an on state and does not need to be switched to an on state by a separate action that is independent from the normal use of the seal of the present invention to seal a value item.

FIG. 7 shows a front view of an RFID 200. The RFID 200 includes a chip 201 and an antenna structure 202, which in the shown preferred embodiment is in the shape of a cross. A support structure 203 may be provided in the form of plastic ribs on the cover 1. The antenna structure 202 may include two or more separate antennas to assist to increase the effective range and/or effective coverage area of the RFID 200. For example, one antenna structure could be used for each arm or each pair of arms of the cross-shaped antenna structure 202 shown in FIG. 7, so that the antennas within the antenna structure 202 are displaced by 90 degrees relative to each other. The chip 201 and antenna structure 202 are located on a flexible substrate 204. Those skilled in the relevant arts will immediately appreciate how to manufacture an RFID 200 of the type shown in FIG. 7 and therefore the structure and operation of the RFID 200 (or any other transponder that may be used as part of an electronic seal of the present invention) will not be described further herein.

The cover 1 may locate the RFID 200, or at least the antenna structure 202 so as to be spaced apart from the sealing mechanism 5. This spaces the antenna structure 202 away from the bolt 2 and the value item, which may be a metal shipping container. The size of the gap between the RFID 200 (and/or antenna structure 202) and the bolt 2 (and/or the value item) may be selected to obtain improved RFID 200 performance.

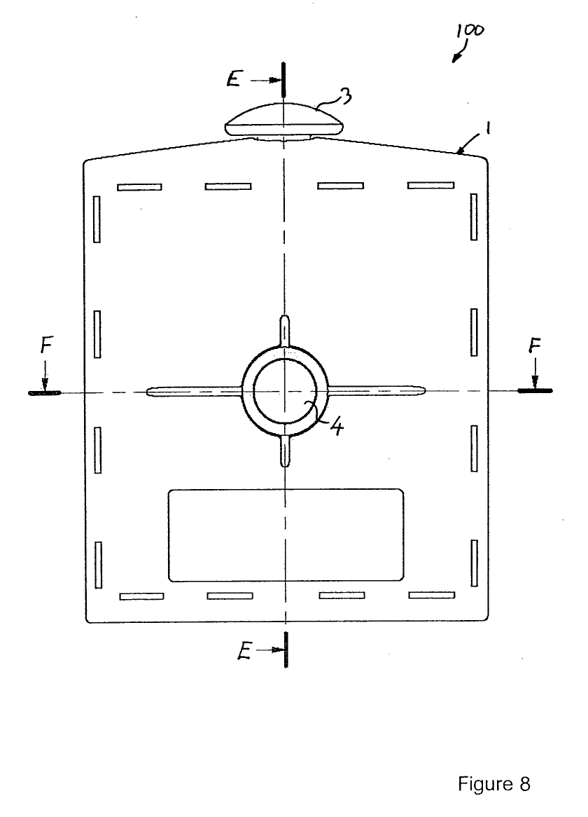

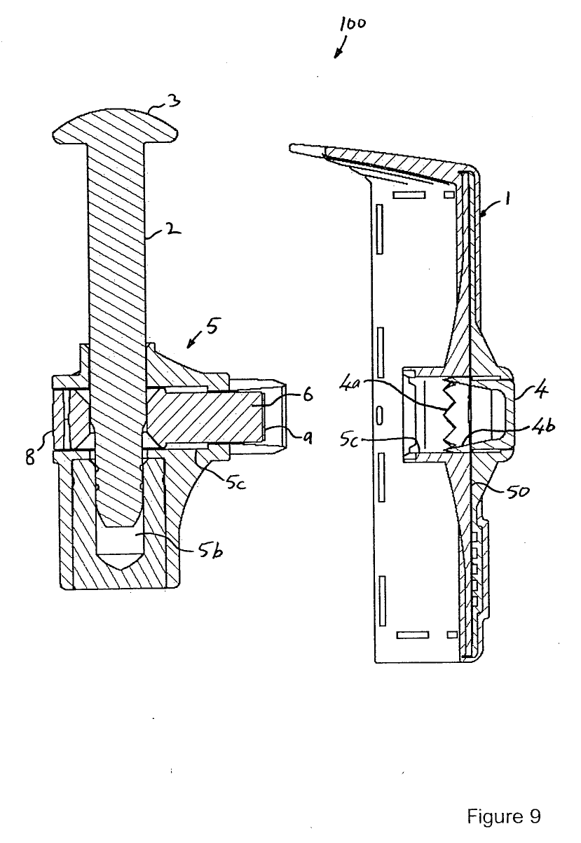

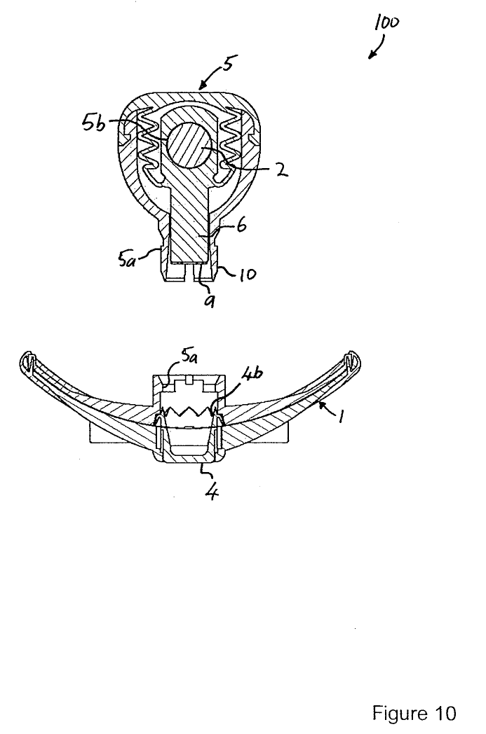

To release the seal 100, an operator pushes the button 4 inwards from the position shown in FIGS. 5 and 6 to the position shown in FIGS. 9 and 10. FIGS. 9 and 10 are cross-sectional views through lines EE and FF of FIG. 8 respectively. This causes an edge, in this embodiment a set of teeth 4a to move into the shaft 5c, thereby severing the chip 201 from the substrate 204, which remains held in place by the clamp 50. This renders the RFID 200 permanently inoperable. Further movement of the button 4 inwards causes the inner surface 4b of the button 4 to contact the outer surface 10 of the engagement mechanism 5a, which disengages the engagement mechanism 5a from the clamp 50. This allows the cover 1 to be removed. The resilient tension provided by the particular engagement mechanism 5a shown in the accompanying drawings may be sufficient to push the cover 1 off the sealing mechanism 5 without operator assistance, at least to an extent so that the engagement mechanism 5a does not reengage.

The seal 100 shown in the accompanying drawings, having a button 4 for destroying a passive transponder, represents the most preferred embodiment of the present invention. However, alternatives exist and may be used depending on the particular requirements for the seal or the preferences of the designers of a seal of the present invention. By way of example only, the chip 201 may be, or may include an electrically erasable programmable read only memory (EEPROM) and depression of the button 4 may be monitored by a controller for the EEPROM, which may cause the chip 201 to erase itself when the button 4 is depressed. Alternatively, a controller may cause the transponder to emit a different signal, for example a different digital sequence after the button 4 has been depressed.

In another embodiment of the invention, the button 4 may be replaced by a lock cylinder that is actuated by a key. Rotation of the lock cylinder by the key may result in the destruction or modification of the transponder, either mechanically or electronically, or even chemically, for example by releasing a chemical that damages the transponder, or by causing a small exothermic reaction or explosion.

In a still further alternative embodiment, the seal 100 may monitor the integrity of the bolt 2 and/or the cover 1, for example by detecting cutting of the bolt, by detecting a change in the electrical properties of the bolt 2, and/or by running a fine wire about the cover and/or bolt and detecting severance of the fine wire. Upon detection of an event that indicates possible removal or tampering of the seal 100, the seal 100 changes the transponder in a detectable way.

In the preferred embodiment described herein, the cover 1 can not be removed without first depressing the button 4 and depressing the button 4 causes the RFID 200 to be damaged. An advantage of this embodiment is that accidental destruction of the RFID 200 will be rare. In an alternative embodiment the button 4 may be omitted and the cover 1 may be removed without first pressing the button 4 or any other actuator. In this alternative embodiment the action of removing the cover 1 may damage or alter the transponder, for example by tearing away a part of an antenna that was secured to the cover 1 and leaving behind a chip of the transponder, or by monitoring the breaking of an electrical circuit that extends over the boundary between the cover 1 and the rest of the seal 100.

Therefore, the seal 100 is tamper evident, in that either no signal will be received from the RFID 200, or if the entire seal 100 is replaced, an incorrect signal will be received. As the bolt 2 is inaccessible through the cover 1, or at least it is difficult to access and cut the bolt 2 without damaging the cover 1, the seal 100 is readily tamper evident and it is difficult to overcome the tamper evident mechanisms in the seal 100.

FIG. 11 shows a diagrammatic representation of part of an alternative seal according to the present invention. The portions of the seal shown are a movable member 60, similar to the movable member 6 of the seal 100, a cover 65 similar to the cover 1 of the seal 100 and an RFID 64, which may be the RFID 200 shown in FIG. 7. The movable member 60 includes weakened portion 61. The weakened portion 61 is located in the movable member 60 between a conductive ring 62 and an aperture 63 (not visible in FIG. 11) that receives a bolt (not shown). The conductive ring 62 operates in the same way as the conductive ring 9 of the seal 100 to render the RFID 64 inoperable when it is in contact with the RFID. 64.

The movable member 63 may be biased against the RFID 64 by any suitable biasing means, including a spring similar to the spring 7. In addition or instead, the movable member 63 is biased against the RFID 64 by two biasing members 66, which are secured to the cover 65. The weakened portion 61 and the biasing members 66 are formed from suitable materials and in an appropriate shape and dimensions so that the resilience of the weakened portion 61 and the biasing members 66 so that weakened portion 61 severs should the cover 65 be removed from the movable member 60 (which is held in place by a bolt). With the weakened portion 61 severed, the biasing members 66 then push the conductive ring 62 against the RFID 64, rendering the RFID 64 inoperable. The cover 65 is shaped so that removal of the conductive ring 62 from the cover 65 can only be achieved by damaging the cover 65.

Those skilled in the relevant arts will appreciate that alternative biasing devices exist, for example a metal spring that may be used instead of the biasing members 66. Also, where the RFID 64 is an EEPROM or similar device, the seal may monitor for removal of the cover 65 and erase the EEPROM. This may be achieved by monitoring for the breaking of one or more conductors, in which case the weakened portion 61 may be omitted.

The curved shape of the cover 1, as can be best seen in FIGS. 3, 6 and 10, imparts a curvature to the RFID inserted in the clamp 50. The RFID 200 and the clamp 50 are both dimensioned so that when the RFID 200 is positioned within the clamp 50, the chip 201 is centred relative to the ring 9.

As the clamp 50 is curved in shape, this in turn forces a curve in the substrate 204, which results in a curved antenna structure 202. This curvature of the antenna structure 202 results in a transmitted signal covering a segment (formed by the rays extending normal from the antenna structure 202 over the active part of the antenna structure 202. This is in contrast to if the antenna were held flat, then most of the transmitted energy would be directed outwards from the antenna transverse to the plane of the antenna. An advantage of the curved antenna design is that an interrogator could be located towards the side of the cover 1 and still receive a signal at useful distances. This is further enhanced by the dual antenna structure of the RFID 200.

Those skilled in the relevant arts will appreciate that the effective transmit distance for the RFID 200 is reduced in the direction normal to the vertical centre line of the front face 1 a of the cover 1 when the antenna is curved. However, this reduced effective transmitting distance is viewed by the applicant as being outweighed by the benefit of having a substantially increased effective transmit distance in other directions. For example, when the seal 100 is used on large shipping containers, it is common practice to place two or more containers in close proximity to each other. This may prevent effective access from the front of the seal 100 by an interrogator of the RFID 200. The curved shape of the RFID 200 in the seal 100 allows the RFID 200 to be interrogated at useful distances from other directions, for example by holding a transponder in the gap between two containers.

Those skilled in the relevant arts will also appreciate that by forming a transponder receptacle having a curved shape along two orthogonal axes, for example by forming a parabolic or spherical surface, the effective area of the transponder may be increased along two orthogonal axes, allowing further flexibility in the location of an interrogator for a passive transponder/a receiver for an active transponder. Furthermore, although the preferred embodiment is a curved transponder receptacle, those skilled in the relevant arts will appreciate that other shapes also allow an effective transmission distance over an increased range of angles relative to a transponder having a planar antenna. For example, the transponder receptacle may define three sides of a trapezoid.

In addition, the curved shape of the cover 1 serves a useful treble purpose of increasing the effective angle of transmission, preventing access to the sealing mechanism 5 and orienting the RFID 200 outwards from a surface next to the seal 100, to which the seal 100 may be mounted. Achieving even two of these purposes with a single structure may result in efficiencies in material and manufacturing costs over alternatives. The advantages of the curved shape of the cover 1 may be achieved whether or not the cover 1 is removable from the sealing mechanism 5 by the use of a button or other actuator. If the cover 1 is not removable from the sealing mechanism 5, then they may be integrally formed, in which case an operator must destruct the cover to access the bolt 2 (or other locking member). Lines of weakness may be formed in the seal 100 to facilitate removal of a cover that has been integrally formed with a sealing mechanism.

The formation of a non-planar antenna structure may have application to any other technologies incorporating transponders and this aspect of the present invention should not be understood as limited to use on electronic seals, although the Applicant believes that it has particular utility when applied to electronic seals.

The cover 1 and sealing mechanism 5 may be constructed from a suitably robust moulded plastic material. The receptacle 5b may need to be constructed from a metal or metal alloy in order to adequately prevent removal of the bolt 2 after it has been engaged with the receptacle 5b. The conductive ring 9 may be aluminium foil and the shaft 6, cap 8 and spring 7 may be polyurethane if they are integrally formed components, or may be separate components, in which case the spring 7 may be a metal spring.

The sealing mechanism 5 of the electronic seal 100 may also have application to other forms of monitoring, either with or without the cover 1. These applications may be realised by replacing the bolt 2 and receptacle 5b with a pin that is readily removed from the sealing mechanism 5. The pin may be secured to a value item, which may including a door of a container, so that if the value item is moved from a particular location the pin is pulled out from the sealing mechanism 5, which results in the conductive ring 9 being pushed against the transponder. Removal of the pin can then be detected without visual inspection by the absence of a response by the RFID 200 to an interrogation signal. Similarly, if the spring 7 is reverse biased, the RFID 200 may become active upon removal of the pin. One example application of a sealing mechanism 5 of this type is on aircraft, where the pin may be secured to the door of a container for a lifejacket or secured to the lifejacket itself, so that removal or tampering with a lifejacket can be readily detected without necessarily having to perform a visual inspection.

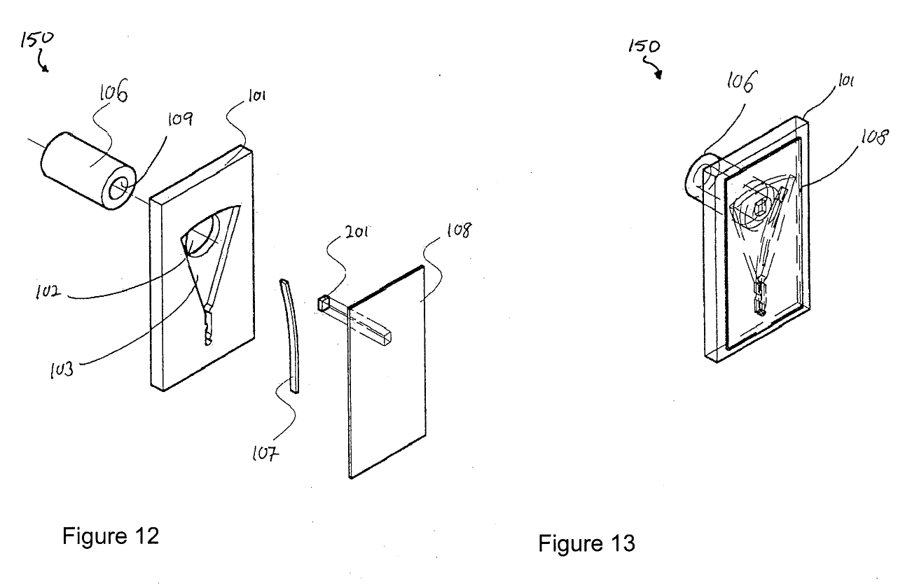

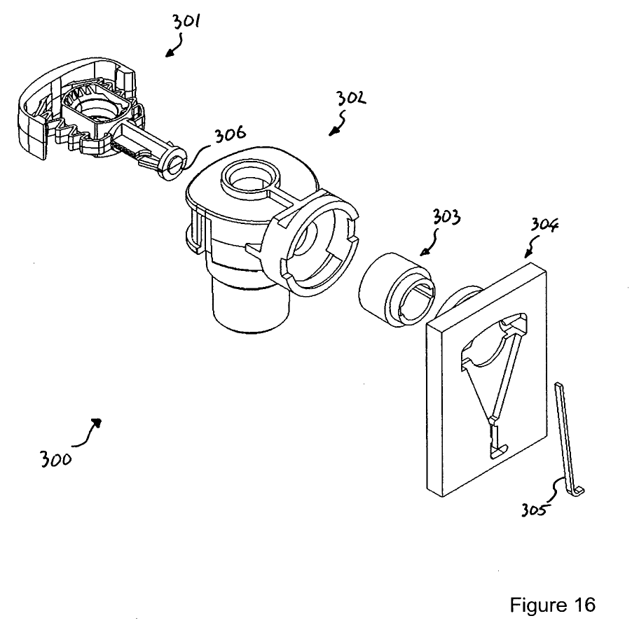

FIG. 12 shows a diagrammatic view of components of another embodiment of the present invention. The device shown in FIG. 12 is also an electronic seal, which is generally referenced by arrow 150 and may have a similar structure to the electronic seal 100 previously described herein. More detailed views of one embodiment of the device shown in FIG. 12 are provided in FIGS. 16 to 18.

The electronic seal 150 may have many of the same components as the electronic seal 100, with FIG. 12 only showing those components that are illustrative of the main structural and functional differences of the electronic seal 150 from the electronic seal 100. The components shown in FIG. 12 are designed to operate with a sealing mechanism that is a modified form of the sealing mechanism 5 previously described and the following description will refer to parts of the sealing mechanism 5.

The electronic seal 150 includes a rear housing 101, which in use is positioned to face the sealing mechanism 5. While the rear housing 101 is shown to be substantially flat in FIG. 12, it may if required have a curved profile like the cover 1 of the electronic seal 100. Like the electronic seal 150, a chip 201 and antenna structure 202 (see FIG. 7) may be provided on a flexible substrate and located between the rear housing 101 and another housing component to form a clamp similar to the clamp 50 of the electronic seal 100. Alternatively, as shown in FIG. 12, the chip 201 may be mounted to a printed circuit board 108, which may include the antenna structure, which is again held in place by a clamp 50 or similar. The rear housing 101 includes an aperture 102 and a generally fan-shaped guide 103 cut out of its front face.

The sealing mechanism 5 includes a trigger 106, held in a fixed position relative to the sealing mechanism 5, but which can under certain conditions that are described below, move along its axis relative to the rear housing 101. The trigger 106 is engaged with the moveable member 6 and extends through the aperture 102 of the rear housing 101. The engagement with the movable member 6 allows the movable member 6 to move backwards when the bolt 2 is inserted into the sealing mechanism 5. This may be achieved, for example by the movable member 6 having a tang that is inserted into a helical groove formed in the trigger 106, so that when the movable member 6 is moved backwards, the tang moves along the helical groove towards the rear of the trigger 106 and the trigger 106 rotates. However, a simple sliding arrangement may also be used. The trigger 106 is held so that it can not move forwards away from the sealing mechanism 5, at least when the bolt 2 is inserted into the sealing mechanism 5.

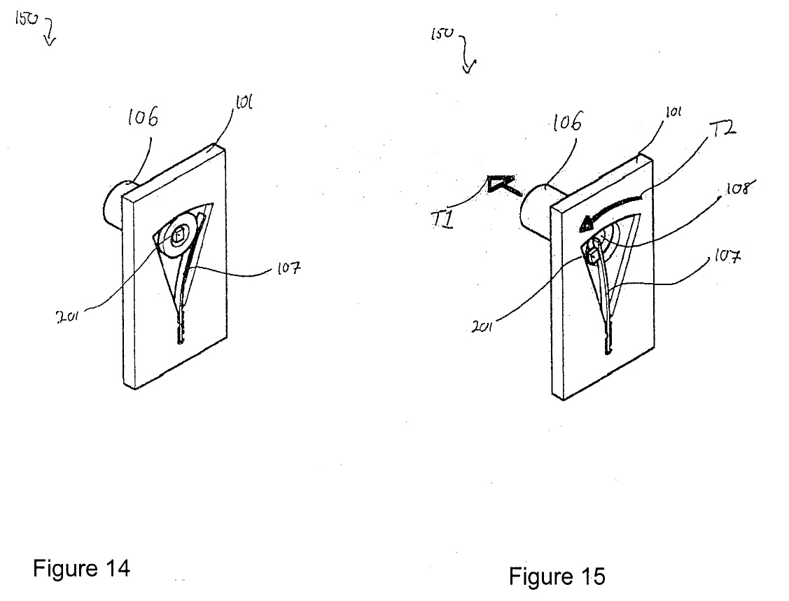

A cut-off spring 107 is located in the guide 103. The spring 107 is biased in one direction, to the left in FIG. 12. The base of the spring 107 is located in the base of the fan shaped guide 103 and then moved to the right of the aperture 102, following which the trigger 106 is extended though the aperture 102. The spring 107 is then allowed to rest against the outer wall of the trigger 106. This position is shown in FIGS. 13 and 14.

The trigger 106 includes a cavity 109, in which the chip 201 is located when the trigger 106 is extended through the aperture 102 of the rear housing 101. The chip 201 is therefore held in line with the spring 107 by the PCB 108 and/or the front portion of the housing, so that when the trigger 106 is pulled back from the aperture 102, it ceases to restrain the spring 107, which moves across the aperture and knocks the chip 201 off the PCB 108 or at least damages the chip 201 so that it no longer operates. This is shown in FIG. 15, the movement of the trigger represented by arrow T1 and the movement of the spring represented by arrow T2.

Because the trigger 106 is connected to the bolt 2 by the moving member 6, which is inelastic, the spring 107 is therefore released when the rear housing 106 is moved forwards. This may occur, for example, if a person attempting to gain access to the sealing mechanism 5 used a crow bar or similar to lever the rear housing 101 away from the sealing mechanism 5.

As described above, in one embodiment, the trigger 106 may be attached to the movable member 6 so as to rotate about the longitudinal axis of the movable member 6 when the movable member 6 is moved backwards within the sealing mechanism 5. In this embodiment, the outer surface of the trigger 106 may also have a helical groove formed in it, which extends to the end of the trigger 106 and is dimensioned to receive the spring 107. When the movable member 6 is in its forward position, the spring 107 may be placed within the groove away from the edge of the trigger 106. The spring 107 may be bent slightly backwards in order to be received by the groove. In this position, the spring 107 is held securely in place.

When the bolt 2 is inserted into the sealing mechanism 5, the movable member 6 moves backwards, causing the trigger 106 to rotate. The spring 107 therefore moves along the helical path to the edge of the trigger 106. In this position, the spring 107 is no longer restrained within the helical groove and will therefore not stay with the trigger 106 if the rear housing 101 is moved forwards away from the trigger 106.

In one embodiment, the trigger 106 may move along its axis to some extent when the movable member 6 is moved due to insertion into the sealing mechanism of the bolt 2. In this embodiment, the trigger 106 may have a conductive ring located on its end, which contacts the PCB 108 when the trigger 106 is in its forward-most position, rendering the chip 201 inactive. The movement of the movable member 6 of the sealing mechanism 5 when the bolt 2 is inserted therein, may cause the trigger 106 to both move backwards and rotate. The movement backwards moves the conductive ring away from the PCB 108, allowing the chip 201 to operate and this movement in combination with the rotation if provided moves the spring 107 to the end of the trigger 106, ready to spring across the trigger 106 if the rear housing 101 moves any further forwards relative to the trigger 106.

As described previously, to the front of the rear housing 101 and the PCB 108 is the front portion of the clamp 50 and a front cover. The front cover may also include a button 4, which when pressed causes the chip 201 to be cut off from the antenna. Suitable lines of weakening may be provided to facilitate this.

FIG. 16 shows an electronic seal 300 including a spring-based protection mechanism like that described with reference to FIGS. 12 to 14. The electronic seal 300 includes a sealing mechanism similar to the sealing mechanism 5 described herein previously. The sealing mechanism is shown in FIG. 16 separated into a key 301 and a lock body 302. The other components of the electronic seal 300 are a trigger 303, a rear housing 304, and a spring 305. Like in the previous embodiments, a front housing (not shown) will act as a clamp for a chip and antenna structure.

A conductive member 306 is provided on the internal end of the key 301 and is biased inwards by key springs 307. The conductive member 306 therefore operates in the same way as the conductive ring 9 (see for example FIG. 9), to prevent operation of the chip and antenna structure until a bolt is inserted through the lock body 302 to move the conductive member 306 away from the chip and antenna structure.

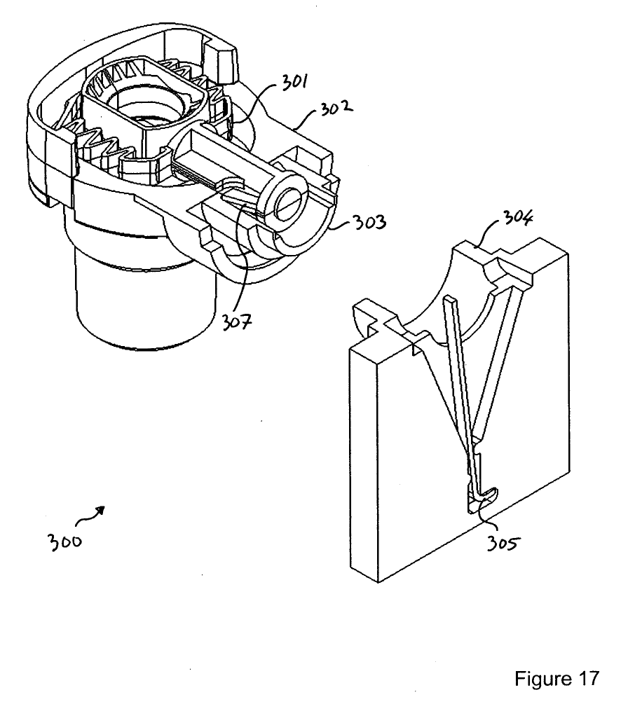

FIG. 17 shows a cut-away view of the components of FIG. 16, with the lock 301, lock body 302 and trigger 303 assembled, and the spring 305 positioned in the rear housing 304. The key 301 is retained in the lock body 302 by resilient protrusions 307, which interlock with the trigger 303, holding the trigger 303 in place relative to the lock body 302. The key 301 is shown in its retracted position, in which the chip and antenna structure would be active.

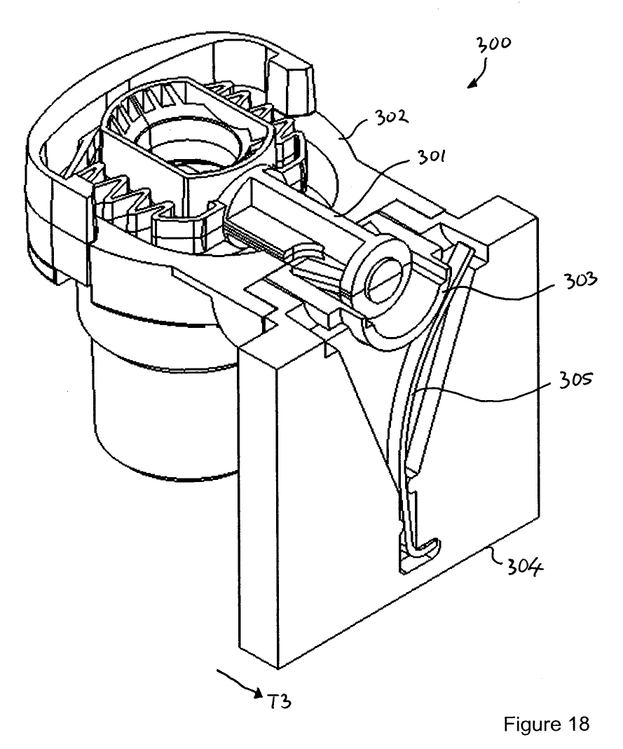

FIG. 18 shows a cut-away view of the assembled components of FIG. 16. In this embodiment, the rear housing 304 removably engages with the lock body 302. For example, the engagement may be frictional or by an interlocking arrangement that is readily overcome. The spring 305 is moved across and is held in a tensioned position by the trigger 303. The trigger 303 remains stationary as the key 301 moves the conductive member 306 into and out of contact with the chip and antenna structure. The removable engagement is in one embodiment sufficiently secure to avoid the cover falling off the lock body 302 and trigger 303, while still being able to be removed by hand. This arrangement avoids the need of a button or other actuator in the front housing to release the cover from the sealing mechanism.

If the rear housing 304 is deflected or moved in the direction of arrow T3, it moves the spring 305 in the same direction until it clears the trigger 303. The spring 303 then moves across the front of the trigger 303 in the area occupied by the chip (or other operative part) of the chip and antenna structure, damaging the structure and rendering it inoperative.

An advantage of the present invention is the ability to provide an electronic device that activates when tampering is detected. This may allow very quick identification of value items that have been tampered with, as all the transponders that are not indicating a tamper condition are off. Such a tamper evident device may be suited to applications where a person tampering with the value item is unlikely to also successfully tamper with the electronic device so as to render it inoperable. The cover 1 of the present invention, without the button 4, may assist to protect the device so as to prevent damage to the electronic device that prevents it from activating.

It will be understood that the invention disclosed and defined in this specification extends to all alternative combinations of the individual features mentioned or evident from the text or drawings. All of these different combinations constitute various alternative aspects of the invention.

It will also be understood that the term “comprises” (or its grammatical variants) as used in this specification is equivalent to the term “includes” and should not, unless the context clearly requires otherwise, be taken as necessarily excluding the presence of other elements or features.

1. An electronic seal comprising a sealing mechanism for sealing a value item, a transponder receptacle, and a cover engaged with the sealing mechanism and which inhibits access to the sealing mechanism, wherein:
the sealing mechanism comprises or connects to a trigger, which is held in a substantially fixed relationship relative to the sealing mechanism when the cover is moved away from the sealing mechanism,
the cover holds therein a spring, which is held in a tensioned position by the trigger, and wherein:
the trigger and spring are located so that when the cover is moved away from the sealing mechanism, the trigger releases the spring, which moves and impacts the transponder, rendering the transponder inoperable.

2. The electronic seal of claim 1, wherein the transponder comprises a chip and antenna structure held in the transponder receptacle, which forms a part of the cover.

3. The electronic seal of claim 2, wherein the cover includes a rear housing component positioned towards the sealing mechanism, and a front housing component, and wherein the chip and antenna structure is clamped between the rear housing component and front housing component.

4. The electronic seal of claim 2, wherein the antenna structure is flexible and the cover has a curved profile so as to maintain the antenna structure in a curved shape.

5. The electronic seal of claim 2, wherein the chip is mounted on a printed circuit board.

6. The electronic seal of claim 5, wherein the antenna structure is also mounted on the printed circuit board.

7. The electronic seal of claim 1, wherein the cover includes an aperture with an internal opening that opens to the transponder receptacle and an external opening that receives therein the trigger.

8. The electronic seal of claim 7, wherein the spring is a resilient elongate member tensioned in a bent configuration and the cover includes an internal spring guide about the internal opening, at least a portion of the transponder extending into and being held in the area occupied by the spring guide, wherein the spring is released by the trigger and cover moving relative to each other so as to withdraw the trigger into the internal opening, and wherein the resulting movement of the spring is guided and constrained by the spring guide so as to impact and damage the portion of the transponder that extends into the spring guide.

9. The electronic seal of claim 8, wherein the spring guide is a fan-shaped guide and the cover includes a spring holder at the base of the fan in which the spring is located and held.

10. The electronic seal of claim 1, wherein the trigger is movable relative to the sealing mechanism and moves from a first position to a second position when the sealing mechanism is moved from an unlocked into a locked position.

11. The electronic seal of claim 10, wherein the trigger, when in the first position, renders the transponder inoperative to transmit a signal.

12. The electronic seal of claim 11, wherein the trigger includes a conductive end, which contacts the transponder when the trigger is in the first position to render the transponder inoperative to transmit a signal and moves away from the transponder when moving to the second position, allowing the transponder to transmit a signal.

13. The electronic seal of claim 10, wherein the trigger is held in the second position when the sealing mechanism is in the locked position so as to prevent movement back to the first position while the sealing mechanism remains in the locked position.

14. The electronic seal of claim 10, wherein the trigger rotates about an axis when the sealing mechanism is moved from the unlocked into the locked position.

15. The electronic seal of claim 14, wherein the trigger includes a holder for the spring, wherein when the sealing mechanism is in the locked position, the holder allows the trigger to release the spring when the cover is moved a certain distance away from the sealing mechanism, and wherein when the sealing mechanism is in the unlocked position, the guide prevents release of the spring when the housing is moved away from the sealing mechanism by said certain distance.

16. The electronic seal of claim 10, wherein the trigger includes a cavity in which a portion of the transponder is located at least when the sealing mechanism is in the locked position, wherein the spring damages said portion of the transponder when released.

17. The electronic seal of claim 16, wherein said portion of the transponder is a chip of the transponder.

18. The electronic seal of claim 1, wherein the cover is removable.

19. The electronic seal of claim 18, wherein the cover is released from the sealing mechanism by actuating an actuator and wherein actuation of the actuator to release the cover damages the transponder, rendering it inoperable.

20. The electronic seal of claim 19, wherein the cover is only releasable from the sealing mechanism by either actuating the actuator or by forcibly removing the cover.

21. A cover for an electronic seal, the cover adapted to be able to be securely engaged with a sealing mechanism for sealing a value item, to thereby inhibit access to the sealing mechanism, wherein the cover includes therein a transponder, a spring, and a trigger that holds the spring in a tensioned configuration, wherein the trigger is arranged to remain substantially in position relative to the sealing mechanism when the cover is engaged with the sealing mechanism and is movable relative to the cover, the arrangement resulting in release of the spring when the cover is moved away from the sealing mechanism, and wherein the spring and transponder are located within the cover so that when the spring is released, it impacts the transponder, rendering the transponder inoperable.
